(19) United States
(12) Patent Application Publication
(10) Pub. No.: US 2007/0094727 A1
(43) Pub. Date: Apr. 26, 2007

(54) Anti-phishing system and methods

(76) Inventor: Moneet Singh, Conshohocken, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/544,063

(22) Filed: Oct. 6, 2006

Related U.S. Application Data
(60) Provisional application No. 60/724,701, filed on Oct. 7, 2005.

(51) Int. Cl. G06F 12/14

(52) U.S. Cl. 726/22

(57) ABSTRACT

A system and methods are provided to allow users cooperating with an entity, such as an online merchant and/or financial institution, to generate and deliver authenticated messages (e.g., electronic messages) the users receive in relation to their use of the entity's products or services in the context where the messages received by users purport to have been sent by the entity. In an illustrative implementation, an anti-phishing computing environment comprises an anti-phishing engine and an instruction set operable to provide one or more instructions to the anti-phishing engine directing the collection and generation of data for use as part of an anti-phishing operation.

### CROSS REFERENCE TO RELATED APPLICATIONS

This non-provisional patent application claims priority to and the benefit of U.S. provisional patent application, 60/724,701, filed on Oct. 7, 2005, entitled, “METHOD AND SYSTEM FOR THE PREVENTION OF ‘PHISHING’ ATTACKS AND FOR THE AUTHENTICATION BY A USER OF ELECTRONIC COMMUNICATIONS” which is herein incorporated by reference in its entirety.

### BACKGROUND

“Phishing” attacks can be considered as large scale distribution of electronic messages to a user population in which the messages are designed to appear to be from a Provider of services (the “Provider”) sent to a subset of the Provider's customers. Typical Providers used in phishing attacks include financial institutions, internet service providers or providers of other communications services.

In a typical phishing operation, the phishing message is “forged” in order to make it appear to have originated from the Provider. Persons implementing phishing attacks, or “phishers,” generally deliver large numbers of such electronic messages, making them analogous to “spam,” albeit sent with a malicious intent, as some spam may be harmless mass advertising. Phishing is especially problematic for financial institutions and online merchants. In a certain context, if customers of such financial institutions and/or merchants fall prey to phishing attacks, these firms face the loss of consumer trust and monetary losses due to fraud.

The phishing message can contain a hypertext link which the user is directed to click or a direct the user “reply to” an electronic messaging address with an electronic response message. Further, the user can be directed to input private or confidential information, such as a user's PIN (personal identification numbers), passwords, social security numbers or account number for an account at the Provider. Using this information, the phisher may gain access to the user's accounts at the Provider or open accounts at another provider of services in the user's name. In this manner, a successful phishing attack can result in the phisher committing an “identity theft.”

A detailed example of a phishing attack is as follows: assume a phisher compiles or obtains a data file containing a large number of email addresses. The phisher then can create a “forged” email to appear to have originated from an enterprise having voluminous customers (e.g., users), for example, a bank. The phisher can obtain (e.g., via the bank's website) the bank's logo and other identifying marks and insert them into the forged email. The phisher may also insert an email address using the bank's domain name into the email so that it appears to have been delivered from the bank.

In the example described, the phishing message might include language such as “Please update your account information by signing into your account at this website” in which the phrase “this website” is a hypertext link not to the bank's website, but to a “forged” website the phisher has created. With current phishing practices, the “look and feel” of the forged website might closely approximate the bank's website and might include form fields into which the unsuspecting user will type his username and password he uses to access the bank's website.

After inputting their confidential information (e.g., username and password), the unsuspecting user might “submit” the information to the computer server hosting the forged website for storage and subsequent use by the phisher. The unsuspecting user may be prompted by a subsequent forged webpage to enter additional data, which can also be captured by the server hosting the forged website.

Depending on the sophistication of the user, a phishing attack can be identified as one if the unsuspecting user observes the actual domain name provided by the phishing link and URL his browser is accessing do not match up (i.e., the accessed site does not correspond to the bank's actual domain name or URL). If the unsuspecting user does reach this conclusion, he will not submit any information via the forged website and the phishing attack will fail.

For a phishing attack to succeed the phisher can either “hijack” or access a web server on which to store forged web pages and to store the information inputted and submitted by the unsuspecting user. Additionally the phisher needs to hijack or access an email server to deliver the forged email messages. The phisher's forged email must also reach users whose emails appear in the data file who will (1) have accounts at the targeted Provider (the bank in the above example) and (2) will not recognize the forged email or forged webpages as elements of a phishing attempt.

Phishing attacks may have a low success rate if only a certain percentage of targeted users have accounts at the targeted Provider. To improve their chance of success, phishers may rely on “targeted attacks.” In one common phishing scheme, phishers can obtain email addresses for users of the eBay.com auction website and deliver forged emails which appear to have been delivered from the company PayPal (eBay.com's payment service). As many eBay users have accounts at PayPal, the phisher thereby increases the likelihood that the recipients will have accounts at this targeted Provider.

In order to better defeat phishing attacks, including targeted phishing attacks, Providers may rely on educating their users on how to spot forged emails and forged web pages. For users of lower computer and Internet literacy (e.g., computer sophistication), identifying forged emails and forged web pages may prove difficult. Other proffered solutions include “marking” e-mail messages with an authentication tag. For example, some Providers, including banks and financial institutions, give their users the options to choose a “graphic” when they are logged into their account, the graphic then being attached to all subsequent email communications from the bank. If a user receives an email purporting to be from the bank, but it lacks the chosen graphic, then the user will know that it is a forged email and part of a phishing attempt. This process, however, could be subverted by phishers who may obtain the graphics from the banks (e.g., via the bank's Internet site) and then randomly append them to their forged emails.

From the foregoing it is appreciated that there exists a need for system and methods that overcome the shortcomings of the prior art.

### SUMMARY

A system and methods are provided to allow users cooperating with an entity, such as an online merchant and/or financial institution, to generate and deliver authenticated messages (e.g., electronic messages) the users receive in relation to their use of the entity's products or services in the context where the messages received by users purport to have been sent by the entity. In an illustrative implementation, an anti-phishing computing environment comprises an anti-phishing engine and an instruction set operable to provide one or more instructions to the anti-phishing engine directing the collection and generation of data for use as part of an anti-phishing operation.

In an illustrative operation, a participating user inputs data representative of the user to the anti-phishing engine. Responsive to the request, the anti-phishing engine generates additional data based on the inputted data and data representative of one or more user behaviors. The inputted data and generated data are then combined to create an authentication tag that can be used in electronic communication between a user and a service provider. In the illustrative operation, the inputted data can comprise user identification and password data and the selection of one or more categories of interest to the participating user (e.g., sports and cars). In the illustrative operation, the generated data can comprise data found in the one or more selected categories (e.g., football and Ferrari) as well as data representative of the participating user's behavior (e.g., paid $40.30 for his last mobile phone bill).

Other features of the herein described systems and methods are further described below.

### BRIEF DESCRIPTION OF THE DRAWINGS

The anti-phishing system and methods are further described with reference to the accompanying drawings in which:

FIG. 1 is a block diagram of an exemplary anti-phishing environment in accordance with the herein described systems and methods;

FIG. 2 is a block diagram of the processing undertaken when performing anti-phishing in accordance with the herein described systems and methods;

FIG. 2A is a block diagram of additional processing undertaken when performing anti-phishing in accordance with the herein described systems and methods; and

FIG. 2B is a block chart diagram of additional processing undertaken when performing anti-phishing in accordance with the herein described systems and methods;

FIG. 3 is a flow diagram showing the processing performed when undertaking anti-phishing in accordance with the herein described systems and methods.

### DETAILED DESCRIPTION

Overview:

Providers such as online merchants and financial institutions may use the method and system described herein to better protect their users from phishing attacks. A person skilled in the arts of computer programming, information technology system architectures, information technology system design and electronic communications technologies may adapt the disclosed method to various information technology systems, regardless of their scale. The person skilled in such arts may use this description and the drawing to implement the method.

The herein described methods can be embodied in an information technology system, such as a system used to manage users of an online commercial site, or an electronic system used for commercial transactions using cellular or other electronic communications and networked computer systems.

Exemplary Anti-Phishing Environment:

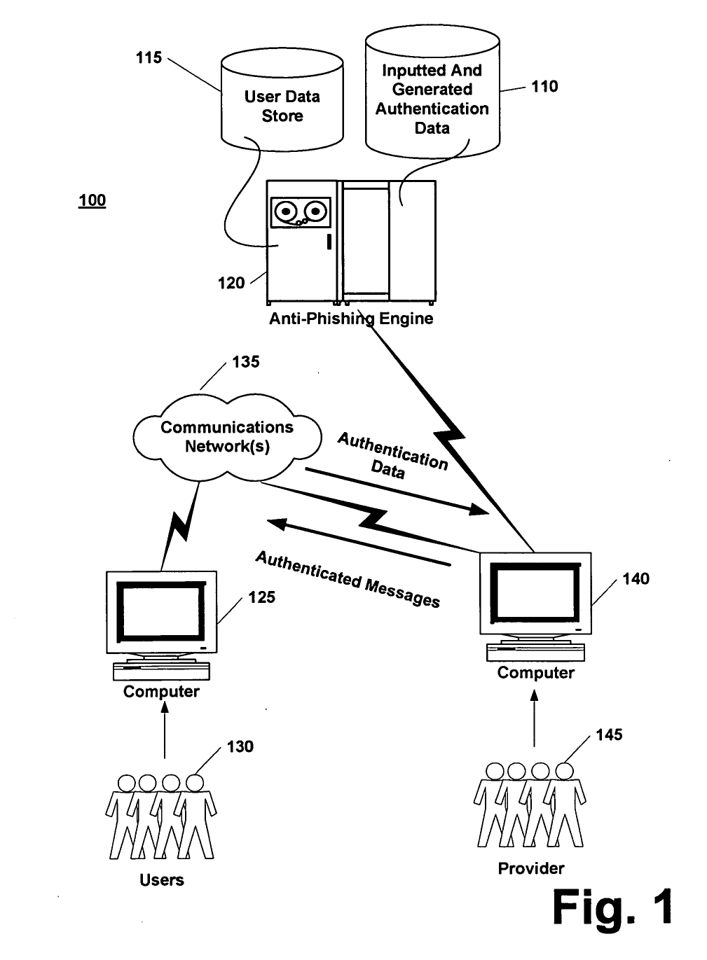

FIG. 1 shows exemplary anti-phishing environment 100. As is shown in FIG. 1, exemplary anti-phishing environment 100 comprises anti-phishing engine 120, user computing environment 125, users 130, communications network 135, provider computing environment 140, providers 145. Further, as is shown in FIG. 1, anti-phishing engine 120 cooperates with user data store 115 and inputted and generated authentication data store 110.

In an illustrative operation, users 130 can cooperate with providers 145 using user computing environment 125 and provider computing environment 140 operatively coupled using communications network 135. In the illustrative operation as part of an exemplary anti-phishing operation, a participating user 130 can be requested by provider 145 to input authentication data using user computing environment 125 cooperating with provider computing environment 140. Responsive to such request, users 130 can input the requested data (e.g., user identification and password data, selection of categories, and user behavior data—the amount of the last bill paid) using user computing environment 125.

Provider computing environment 140 cooperating with anti-phishing engine 120 can illustratively operate to process received inputted user data for storage in inputted and generated authentication data store 110. Further, provider computing environment 140 can illustratively operate to cooperate with anti-phishing engine 120 to generate additional user authentication data using the user inputted data (e.g., associate words with the selected categories—that is if the user selects sports and cars as their categories, associate the words “football” and “Ferrari” for that user) and store the additional authentication data in inputted and generated authentication data store 110. Further anti-phishing engine 120 can illustratively operate to generate an authentication tag for each user using the user inputted and engine generated data for inclusion in electronic communications (e.g., e-mail messages) between the provider and the user.

It is appreciated that although exemplary anti-phishing environment 100 is described to employ specific components having a particular configuration that such description is merely illustrative as the inventive concepts described herein can be performed by various components in various configurations. For example, although provider computing environment 140 and anti-phishing engine 120 are described to be separate in FIG. 1, such description is merely illustrative as these two computing environments can exist in a single computing environment.

Anti-Phishing:

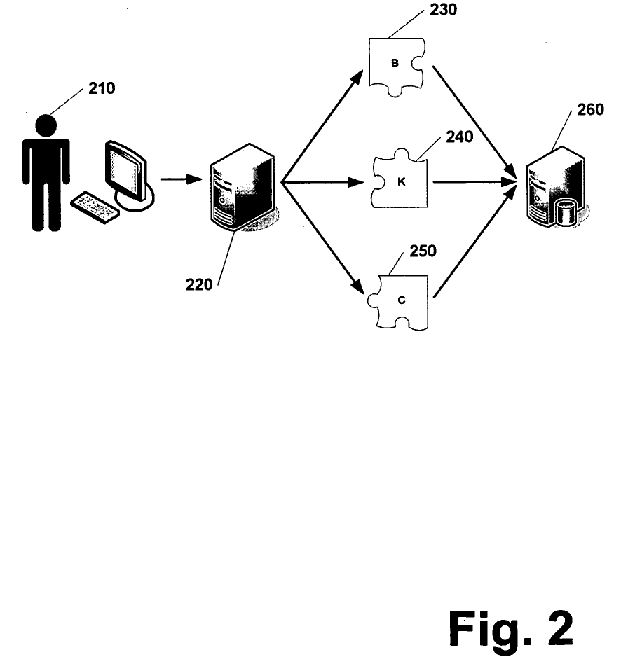

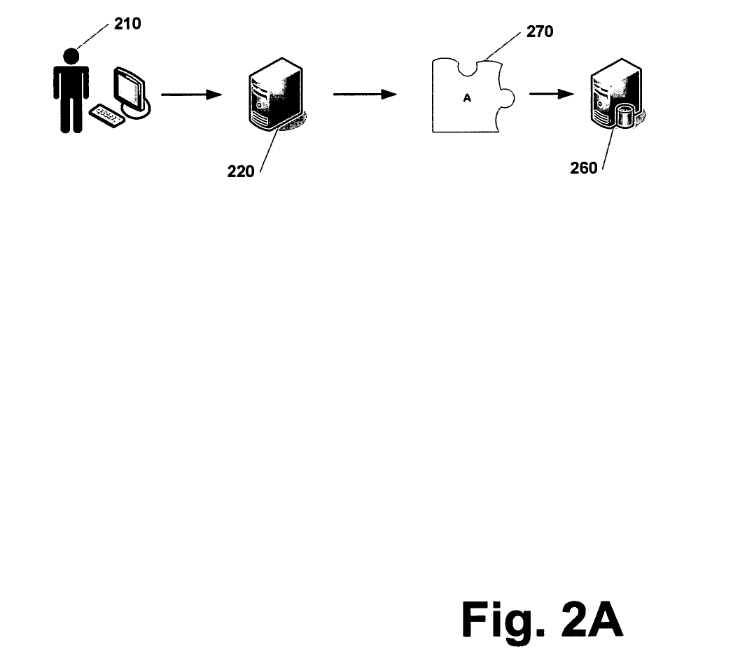

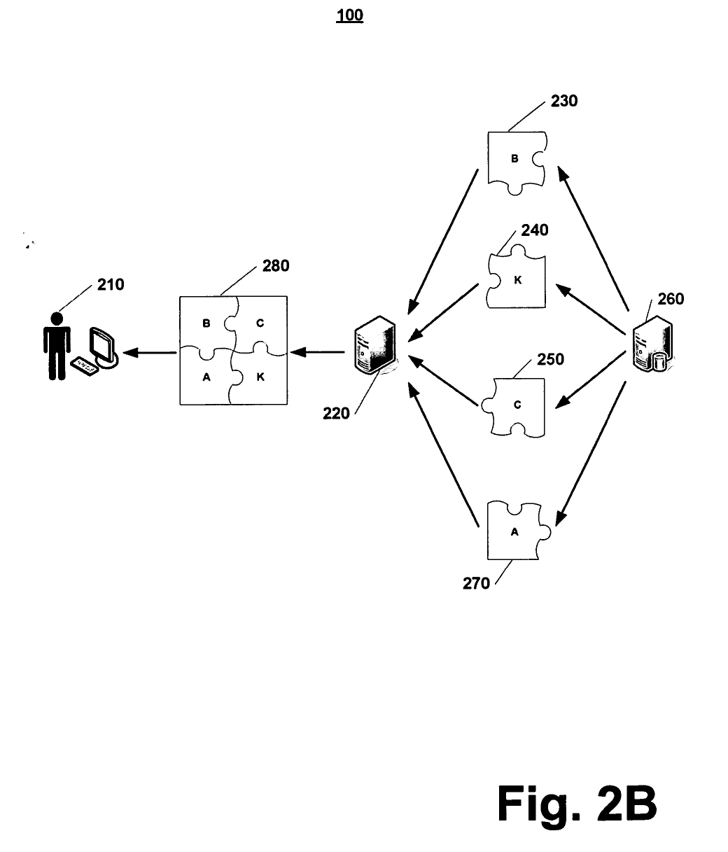

It is appreciated that exemplary anti-phishing environment 100 of FIG. 1 can maintain various operations and features. FIGS. 2, 2A, and 2B provide illustrative implementations of exemplary processing performed by exemplary anti-phising environment 100.

As is shown in FIG. 2, exemplary anti-phishing processing begins at block 210 where information can be imputed by a participating user to the anti-phishing engine (120 of FIG. 1) during a set-up or “account management” process for the Provider (140 of FIG. 1). In an illustrative implementation, the set-up processes can comprise a “new user” signup process (not shown) offered by a an entity to potential subscribers on the entity's website (e.g., the website of a financial institution).

In an illustrative operation, as part of the user set-up or account management processing block 210, a participating user can input various information to a Provider at block 220 including but not limited several pieces of basic identity information 230 such as their name and a user ID. Alternatively, the identifiers can be generated for the participating user by the Provider's information technology system (e.g., anti-phishing engine 120 of FIG. 1). In this illustrative operation, the automatically generated identifiers can include a system generated user ID, screen name or account number.

In the illustrative operation, the system can also designate one piece of the basic identity information, such as the user's first name, as the piece of basic identity information which can appear in all electronic communications from the Provider to the user. This piece of information corresponds to block 230. This piece of information, along with all other basic identity information submitted by the user, is stored on an electronic storage system 260 that can be controlled by a Provider.

Further, in the illustrative operation, a participating user can choose a plurality of “keywords” during the set-up or account management process. As an example, the Provider's information technology system 260 can prompt the user to enter three keywords. These keywords are “free form” inputs gathered from the user and may be limited in character length. The Provider's information technology system (e.g., anti-phishing engine 120 of FIG. 1) can also suggest types of keywords, such as the name of the user's pet or the brand of the user's automobile. The user can then enter a requested number of different keywords at block 240. The additional inputted data can be stored at block 260 in an exemplary electronic storage system.

Further, in the illustrative operation, a participating user can select a “category” from a predetermined listing of a plurality of categories as supplied by the Provider's information technology system during the set-up or account management process. The categories comprise elements which would be familiar to users acquainted with the category; as an example, the Provider's information technology system may list a category called “Musicians,” the elements of which would be the last names of musicians, such as Armstrong, Bach, Chopin and Dvorak. The user selects his/her category from the predetermined list and his/her choice, represented by block 250, can be stored on an exemplary electronic storage system.

FIG. 2B shows additional processing performed when undertaking anti-phishing operations. As is shown in FIG. 2B, a Provider's information technology system can illustratively operate to track selected activities by a participating user that the participating user can perform in conjunction with the services offered by the Provider. As an example, if the Provider is a financial institution, the user's activities can be the number of financial transactions performed during a given time period. The Provider's information technology system can illustratively operate to track information related to these activities and can store the tracked information related to them, as represented by block 270, in an exemplary electronic storage system.

In the illustrative operation, once the above-described information is inputted by the participating user and processed by the Provider, the participating user can be informed by the Provider's information technology system that any valid message from any service managed by the Provider should include four pieces of information: “B,” the piece of information related to the user's basic data (block 230); “K,” one of the user's selected keywords (block 240); “C,” a piece of information related to the user's selected category (block 250); and “A,” a piece of information related to the participating user's recent activities using the Provider's services (block 270). By verifying that each electronic message claiming to be from the Provider contains these four pieces of information, the participating user may quickly validate the electronic message as authentic and to have been composed and delivered by the Provider.

FIG. 2B depicts the processing performed by the Provider's information technology system when undertaking anti-phishing operations. When it is time for the Provider's information technology system to deliver an electronic message to the user 210, the Provider's information technology system 220 can illustratively operate to query the electronic storage system 260 and obtain the following: the information represented by the “B” (block 230), which is a piece of information related to the user's basic data; one of the user's keywords, represented by the “K” (block 240); a piece of information related to the category chosen by the user, represented by the “C” (block 250); and a piece of information related to the user's recent activities using the Provider's services, represented by the “A”(block 270). The Provider's information technology system 220 can then prepare the electronic communication, inserting each of the queried pieces of information into the electronic communication, and can deliver the electronic communication with the four pieces of information as represented by block 280 to participating user 210.

By way of example, assume a participating user creates a new account with a Provider (e.g., a financial institution). The user then chooses the username “Hoops22” upon signup, and chooses the anti-phishing authentication keywords “Pug” and “Parrot.” The user then selects the category “Cooking Utensils” from the list of available categories presented by the Provider's information technology system. These pieces of information are then stored in the user's a database entry by the Provider's information technology system.

At a later date, the Provider's information technology system communicates with the user to provide information abut a new service being offered by the Provider (e.g., free money market account). The Provider's information technology system composes an electronic message to be delivered to a selected and then queries its electronic storage system to retrieve anti-phishing authentication data for including in the electronic message. In this context, the Provider's information technology system illustratively operates to obtain from the electronic storage system the user's user ID (“B”) (block 230), chooses the keyword “Pug” (“K”)(block 240) and chooses the word “Dish” (“C”)(block 250) from the category “Cooking Utensils.” The Provider's information technology system also determines that the user has paid three bills electronically during the current month (“A”)(block 270). The Provider's information technology system will then add these pieces of information (280) to its electronic message. The final electronic message could read as follows: “Dear Hoops22, please login to your account with us. You have paid 3 online bills this month. Pug Dish.”

From this message, the user recognizes his username or user ID (“B”), one of his keywords (“K”), a word corresponding to his selected category (“C”), and the number of transactions performed during that month (“A”). By recognizing these four discrete pieces of information sent in one single, unified communication, the user may conclude that the electronic message has been sent from the Provider and is not a phishing attempt. As three of the four pieces of information have a “dynamic” quality—the keyword dynamically selected from a list, the category word dynamically selected from a list, and the number of transactions dynamically generated according to the user's behavior—phishers will have a difficult time establishing an exact “match” for the user through a process dependent upon the random generation of words.

In an illustrative implementation, the herein described system and methods can implement a graphic as well as textual pieces of information when it is used for electronic communications. In this illustrative implementation, an image can be selected by the Provider's information technology system to deliver from the user's chosen category instead of a word. For example, if the user chose the category “sports,” then the electronic communication could include an image of a basketball, golf club, football, etc. In the illustrative implementation, customer can be allowed to upload several graphics to a Provider's website and use the graphics in the role of the keyword in the method described herein.

As a text based approach, the method allows for message validation in formats such as SMS, the Short Messaging Service on mobile phones. The method could also be used for messages delivered via MMS, the Multimedia Messaging Service on mobile phones, and incorporate both graphics and text.

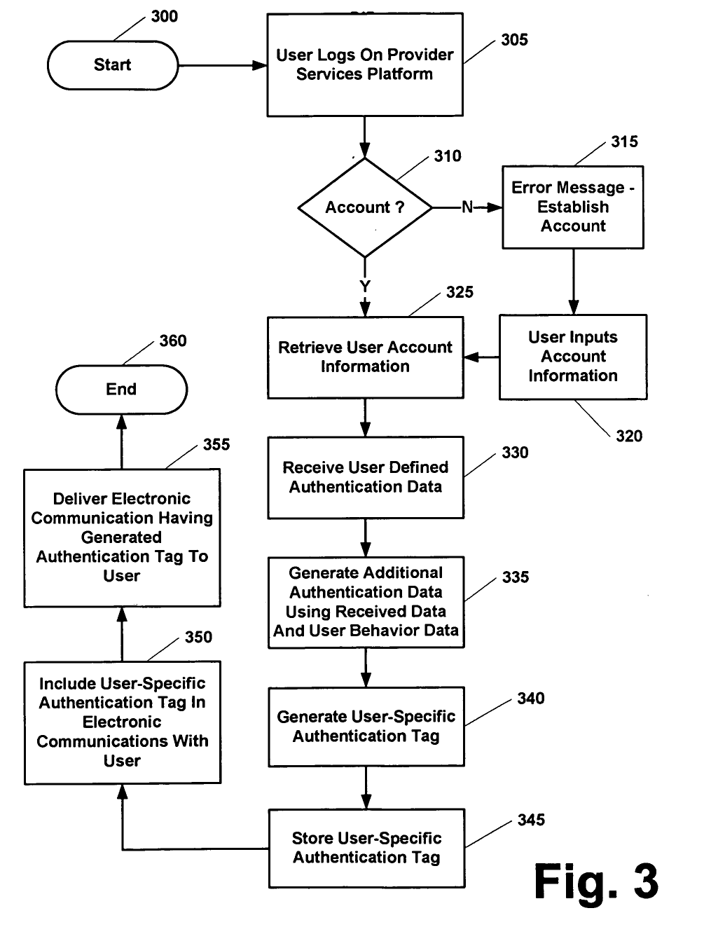

FIG. 3 is a flow chart showing exemplary processing performed when undertaking anti-phishing operations in accordance with the herein described systems and methods. As is show, processing begins at block 300 and proceeds to block 305 where a user longs on to a Provider services platform. Processing then proceeds to block 310 where a check is performed to determine if the participating user has an account with the Provider. If the check at block 310 indicates that the user does not have an account, processing proceeds to block 315 where an error message is generated to the user to establish an account. From there processing proceeds to block 320 where the user inputs account information to generate an account. Processing then proceeds to block 325 and proceeds from there.

However, if the check at block 310 indicates that the participating user has an account, processing proceeds to block 325 where the user account information is retrieved. User defined authentication data is then received from the user at block 330. Additional authentication data using the received data and user behavior data (e.g., data attributed or associated with the user account—bill payment history data) is then generated at block 335. Using the received user defined data and generated authentication data, a user-specific authentication tag is generated at block 340. The user-specific authentication tag is then stored at block 345.

From there, the user-specific authentication tag is included in electronic communications with the user at block 350. Electronic communication having generated authentication tag is then delivered to the user at block 355.

It is understood that the herein described systems and methods are susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system for anti-phising comprising:
an anti-phishing engine; and
an instruction set operable to provide at least one instruction to the anti-phishing engine to process electronic data according to a selected anti-phishing paradigm,
wherein the anti-phishing paradigm comprises the receipt of data representative of a participating user and the generation of data representative of one or more behaviors of participating user to generate an authentication tag.

2. The system as recited in claim 1 wherein the anti-phishing engine comprises a computing environment.

3. The system as recited in claim 2 wherein the instruction set comprises a computing application operable on a computing environment.

4. The system as recited in claim 3 further comprising a data store cooperating with the anti-phishing engine to store generated authentication tags.

5. The system as recited in claim 4 further comprising a communications network.

6. The system as recited in claim 5 wherein the communications network comprises a fixed wire network, a wireless network, a mobile network, and the Internet.

7. The system as recited in claim 1 wherein the instruction set direct participating users to input to the anti-phishing engine data representative of the participating user.

8. The system as recited in claim 1 wherein the generated authentication tag comprises text and graphics.

9. The system as recited in claim 1 wherein the user behavior data comprises data representative of a user's interaction with a service provider.

10. The system as recited in claim 1 wherein the anti-phishing engine is operated by a services provider.

11. A method for anti-phishing comprising:
receiving data representative of a user;
receiving data representative of user's selection of one or more categories;
retrieving data representative of a user's previous behavior; and
generating an authentication tag using the received user data, received user selection data, and retrieved user behavior data.

12. The method as recited in claim 11 further comprising storing the generated authentication tag.

13. The method as recited in claim 12 further comprising including the generated authentication tag as part of an electronic communication sent to the user.

14. The method as recited in claim 11 further comprising associating one or more words for each of the data received representing each of the one or more selected categories when generating the authentication tag.

15. The method as recited in claim 11 directing the user to input data representative of the user.

16. The method as recited in claim 11 directing the user to input data representative of the selection of one or more categories.

17. The method as recited in claim 11 further comprising selecting a graphic to include as part of the generated authentication tag.

18. The method as recited in claim 11 further comprising directing the user to upload a selected graphic for use in generating the authentication tag.

19. The method as recited in claim 11 further comprising receiving data representative of the behavior of a user.

20. A computer readable medium having computer readable instructions to instruct a computer to perform an anti-phishing method comprising:
receiving data representative of a user;
receiving data representative of user's selection of one or more categories;
retrieving data representative of a user's previous behavior; and
generating an authentication tag using the received user data, received user selection data, and retrieved user behavior data.
